(19) United States
(12) Patent Application Publication
(10) Pub. No.: US 2014/0014739 A1
(43) Pub. Date: Jan. 16, 2014

(54) IMPINGEMENT SPRINKLER

(71) Applicant: Tzu-Lin HUANG, Xianxi Township (TW)

(72) Inventor: Tzu-Lin HUANG, Xianxi Township (TW)

(21) Appl. No.: 13/548,520

(22) Filed: Jul. 13, 2012

(51) Int. Cl. B05B 3/02

(52) U.S. Cl. 239/230

(57) ABSTRACT

An impingement sprinkler has a main body, guiding member, tilting regulator, steering control member and steering limiter. The tilting regulator is arranged between the support of main body and the tubing portion on the lower end of the main body, so that the main body can be tilted to change the outflow angle of sprinkler head. The guiding member is located on the support of main body, driving the steering of the main body. The steering control member is installed on one side of the support of the main body to change the rotational direction of the main body. When the main body is tilted, the poke rod of steering control member could be maintained into the limiting ring frame, so that the first or the second limiting member could intervene the poke rod to make the main body retain the steering action.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The present invention relates generally to an impingement sprinkler, and more particularly to an innovative one which is used to limit the poke rod in the limiting ring frame so as to enable steering of the impingement sprinkler 2. Description of Related Art Including Information Disclosed Under 37 CFR 1.97 and 37 CFR 1.98.

Impingement sprinklers are extensively used for gardening irrigation and spraying, since circulating or reciprocating water sprinkling of the impingement sprinklers can be realized in an annular zone. In order to further improve its practicability, a tilting impingement sprinkler has been developed, allowing to adjust the outlet angle by tilting upwards or downwards (i.e. when tilting upwards, the parabolic sprinkling distance is bigger, or otherwise smaller) so as to meet the users' diversified demands. The present invention is intended to improve the steering structure of this tilting impingement sprinkler

A conventional impingement sprinkler generally comprises: a main body, a water tubing portion located at bottom of the main body, a swing frame installed on the main body, a steering structure and a tilting rotational structure. Of which, the steering structure generally comprises of two rotatable limiting baffles set externally on the water tubing portion and a poke rod located on one side of main body and extended downwards between two limiting baffles. When the main body is driven to rotate by the swing frame, the poke rod is also driven to abut onto a limiting baffle, allowing the poke rod to swing and link the internal members for the steering of the main body. However, the conventional poke rod is located between two limiting baffles, and the periphery of which is designed into an open state due to lack of any limiting structure. So, when the main body is tilted upwards, the poke rod will be located beyond the limiting baffle and disengaged from abutting state, this will lead to loss of main body' steering function, failure of rotary sprinkling and unbalanced sprinkling, thus significantly reducing its convenience and practicability.

Thus, to overcome the aforementioned problems of the prior art, it would be an advancement if the art to provide an improved structure that could significantly improve the efficacy.

Therefore, the inventor has provided the present invention of practicability after deliberate design and evaluation based on years of experience in the production, development and design of related products.

### BRIEF SUMMARY OF THE INVENTION

Based on the innovative design of the present invention wherein the impingement sprinkler mainly comprises a limiting ring frame located on the steering limiter, when the main body of the present invention is tilted for adjustment, the poke rod set on the steering control member could be maintained into the limiting ring frame, allowing the first or second limiting member of the steering limiter to intervene the poke rod so that the main body could retain the steering action, preventing the shortcomings that the poke rod could not contact with the first and second limiting members when the main body is tilted upwards or downwards. Thus, the impingement sprinkler could accurately conduct the steering action for sprinkling, so as to improve the product's practicability and convenience.

Although the invention has been explained in relation to its preferred embodiment, it is to be understood that many other possible modifications and variations could be made without departing from the spirit and scope of the invention as hereinafter claimed.

### BRIEF DESCRIPTION OF THE SEVERAL VIEWS OF THE DRAWINGS

FIG. 1 is an exploded perspective view of the present invention.

FIG. 2 is an assembled perspective view of the present invention.

FIG. 2 is a lateral view of the present invention.

FIG. 4 is an adjusting status view of the second limiting member of the present invention.

FIG. 5 is a position status view of the poke rod and the first/second limiting members of the present invention.

FIG. 6 is an adjusting status view of the present invention that is tilted downwards.

FIG. 7 is an adjusting status view of the present invention that is tilted upwards.

FIG. 8 is a partially enlarged view of the present invention that is provided with a snapping positioner.

### DETAILED DESCRIPTION OF THE INVENTION

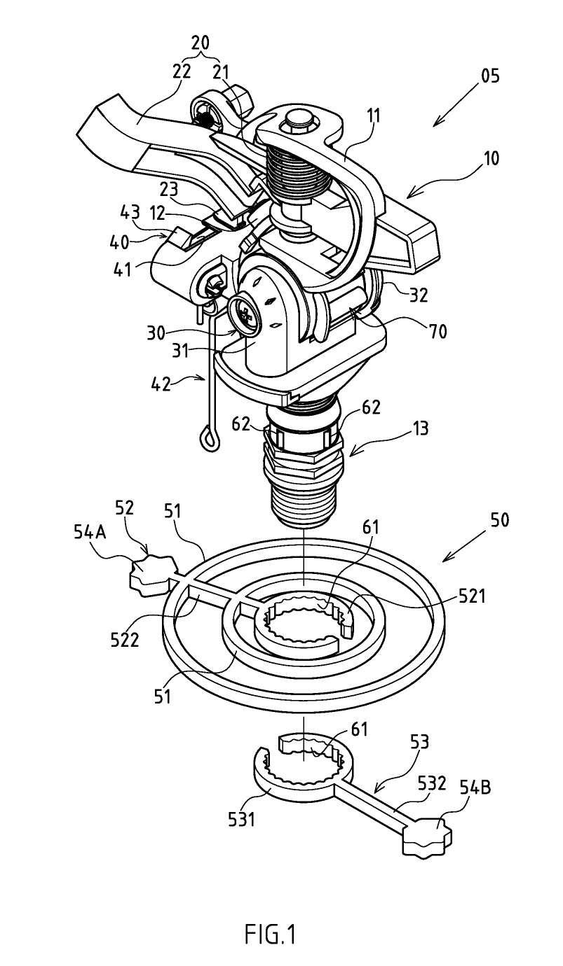

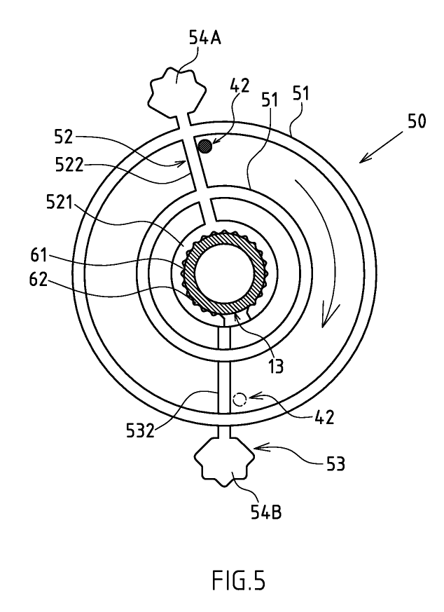

FIGS. 1-5 depict preferred embodiments of the impingement sprinkler of the present invention, which, however, are provided for only explanatory objective for patent claims.

Said impingement sprinkler 05 comprises a main body 10, comprising of a support 11, and a sprinkler head located near the lower edge of the support 11. Of which, a tubing portion 13 is installed on the lower end of the main body 10.

A guiding member 20 is located on the support 11 of the main body 10, and includes a torsional spring 21 and a swing member 22. Of which, a first stopper 23 is arranged at one side of the swing member 22, which is located correspondingly to the front end of sprinkler head 12. The tubing portion 13 located on the lower end of the main body 10 is used for coupling the water pipe (not shown in drawings), so that water is guided into the support 11 after flowing through the tubing portion 13, and then sprayed out via sprinkler head 12 to drive swing member 22 to swing back and forth (swinging status of swing member 22 not shown in drawings), driving the steering of the main body 10.

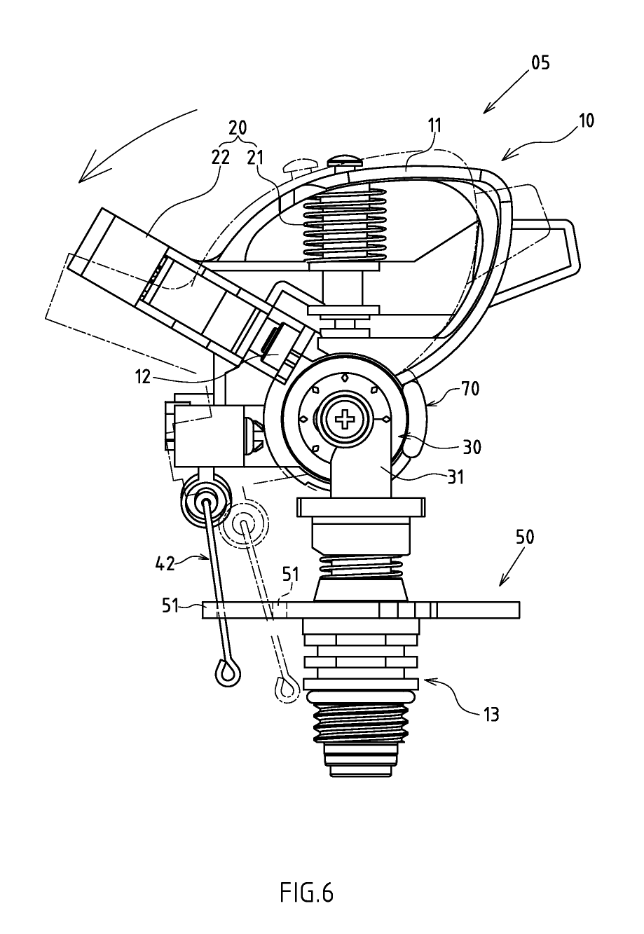

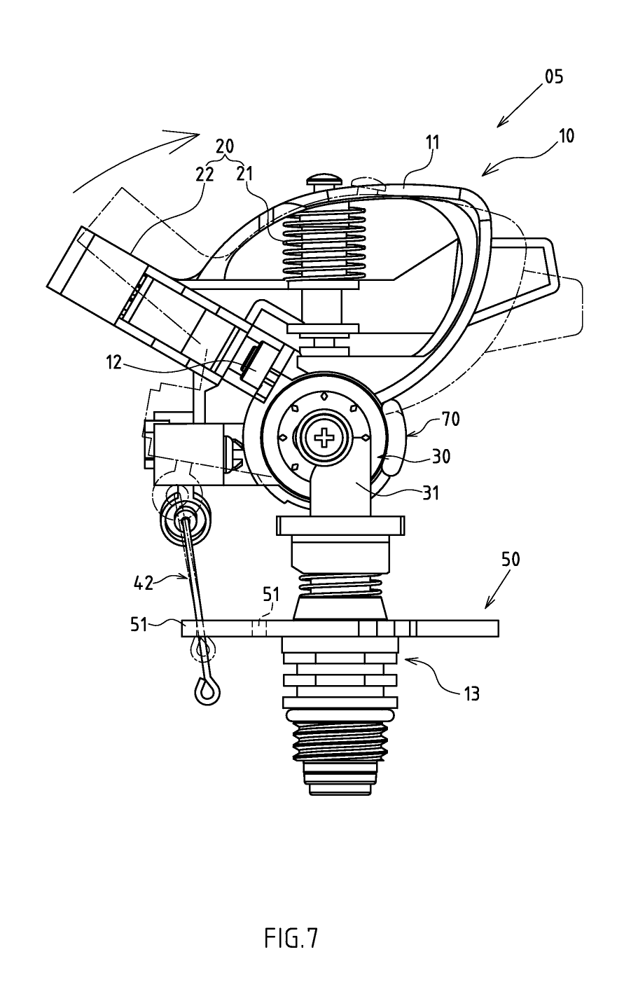

A tilting regulator 30 is arranged between the support 11 of main body 10 and the tubing portion 13, so that the main body 10 can be tilted to change the outflow angle of sprinkler head 12 (referring to FIGS. 6 and 7).

A steering control member 40 is set at one side of the support 11 of the main body 10, and includes a second stopper 41 and a poke rod 42 located below the second stopper 41 in a swinging and extension state. Through intervention of the poke rod 42, the second stopper 41 and first stopper 23 can be linked in a corresponding or staggered status, allowing to change the rotational direction of the main body 10. Moreover, the first stopper 23 disclosed in the preferred embodiment is designed into a hook-shaped block arranged at bottom of the swing member 22. The second stopper 41 is set at one side of the support 11 of the main body 10 and designed into an elongated block. A hook 43 opposite to the first stopper 23 is formed at one end of the second stopper 41, and a pivot 44 (only marked in FIG. 3) is set in the middle of the second stopper 41, which is controlled to swing around the pivot 44 by the swinging of the poke rod 42. So, the hook 43 is lifted up correspondingly to the first stopper 23, or lifted down in staggered state (FIG. 3 depicts the staggered state between the hook 43 and the first stopper 23).

A steering limiter 50 is installed at interval on the preset position of the tubing portion 13 for limiting and intervening the poke rod 42, which comprises at least a limiting ring frame 51, installed at interval on the exterior of tubing portion 13 (two limiting ring frames 51 are configured at interval in the preferred embodiment).

A first limiting member 52, designed into an extension rod pattern, is installed on the tubing portion 13 and laterally connected with the limiting ring frame 51. The first limiting member 52 could link the limiting ring frame 51 to rotate for adjusting the position along the circumferential direction of the tubing portion 13.

A second limiting member 53, designed into extension rod pattern, is installed on the tubing portion 13 and located above or below the first limiting member 52. It could rotate for adjusting the position along the circumferential direction of tubing portion 13. It is at least laterally extended to the limiting ring frame 51.

With this design of the limiting ring frame 51 of the steering limiter 50, when the main body 10 is tilted for adjustment, the poke rod 42 could be maintained into the limiting ring frame 51, so that the first or second limiting member 52, 53 could intervene the poke rod 42 to make the main body 10 retain the steering action, preventing the shortcomings that the poke rod 42 could not contact with the first and second limiting members 52, 53 when the main body 10 is tilted upwards or downwards.

The present invention is operated as follows:

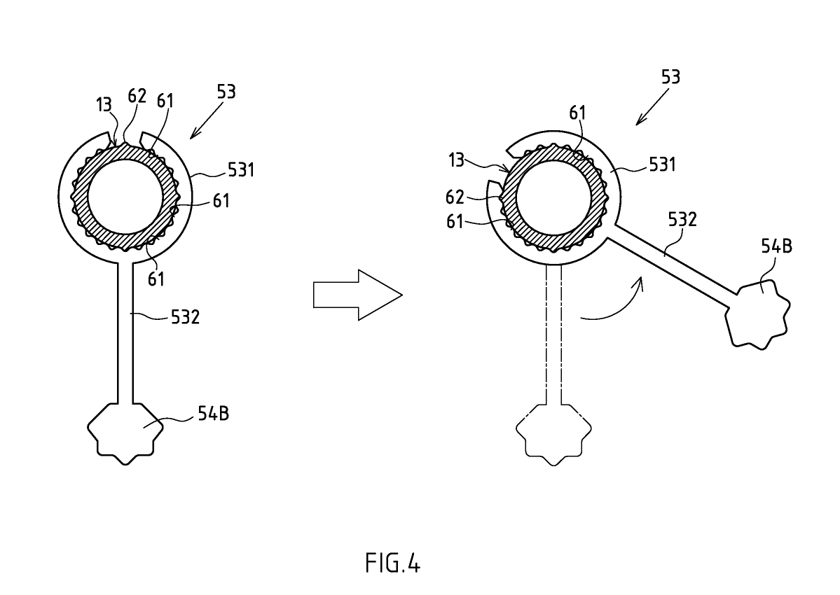

Referring to FIGS. 4, 5 and 6, the first limiting member 52 arranged on the steering limiter 50 comprises of an annular assembly portion 521 and a connecting rod 522 extended laterally from the assembly portion 521. Of which, the assembly portion 521 is assembled outside of the tubing portion 13, and the connecting rod 522 could be connected with the limiting ring frame 51. A wide-surface hand-held member 54B is formed on one end of the connecting rod 522 for the users.

Furthermore, the second limiting member 53 comprises of an annular sleeving portion 531 and a stop rod 532 extended from the exterior of the sleeving portion 531. The sleeving portion 531 could be sleeved on the exterior of the tubing portion 13. Also, a hand-held member 54B is formed on one end of the stop rod 532, allowing to users to hold and adjust the second limiting member 53.

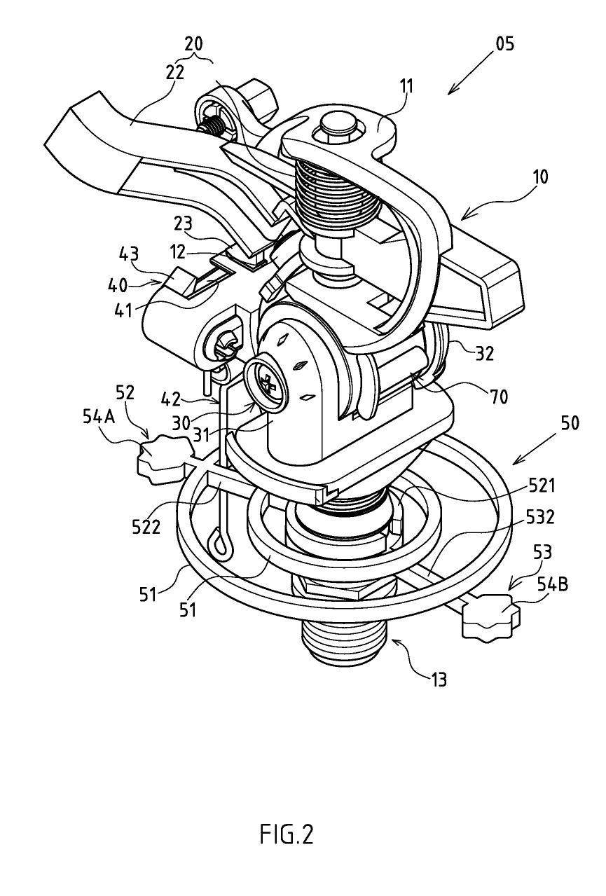

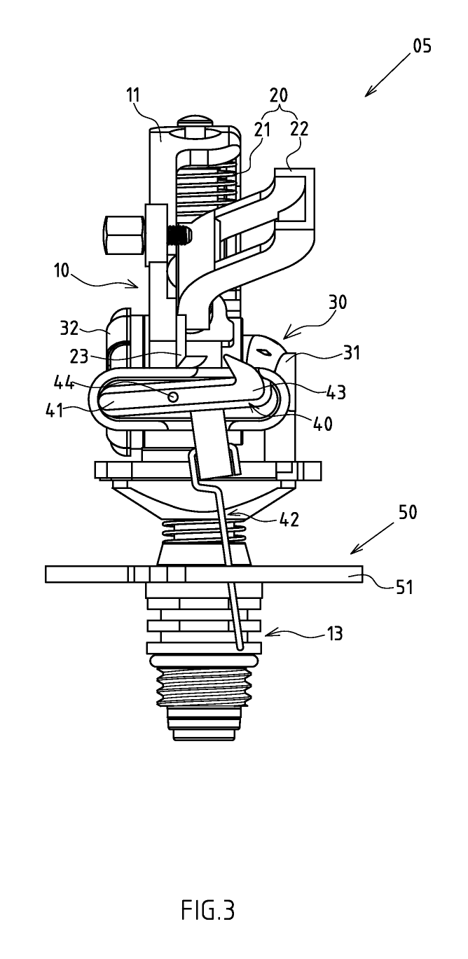

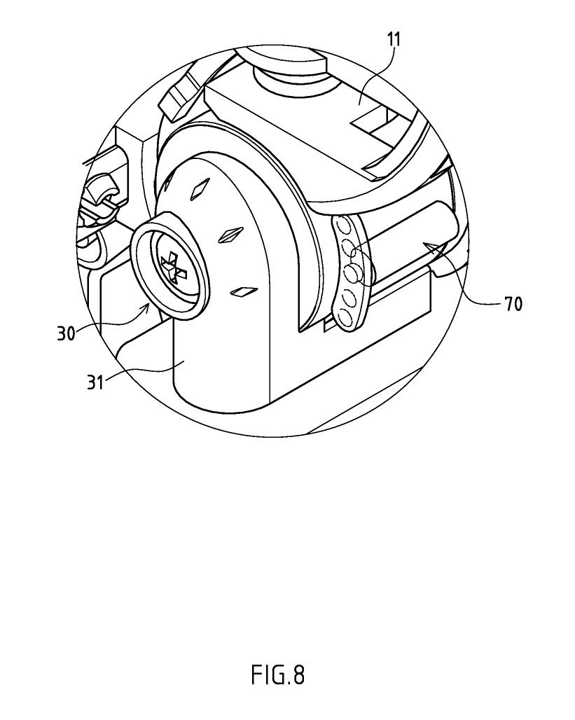

In this embodiment, multiple positioning gears 61 are configured at interval onto inner sides of the assembly portion 521 located on the first limiting member 52 and the sleeving portion 531 on the second limiting member 53. At least a snap lock 62 is circularly set on the lateral tubing portion, enabling meshed positioning effect when adjusting the first and second limiting members 52, 53. Referring to FIGS. 2 and 6-8, the tilting regulator 30 comprises of an axle seat 31 installed on the top of tubing portion 13 and a pin joint 32 pivoted onto the axle seat 31. Of which, the axle seat 31 could be connected to one side of the support 11 set on the main body 10, and the pin joint 32 could penetrate the support 11 for pivoting of the axle seat 31, so that the main body 10 could rotate along the axis of pin joint 32, thus changing the outflow angle of the sprinkler head 12. In this embodiment, one side of the axle seat 31 and the bottom end of support 11 are provided with a snapping positioner 70 which is preferably designed into an elastic fixed pattern and comprised of elastic flange matched with the positioning hole (referring to FIG. 8), so that the main body 10 could be positioned during rotation. When the body 10 is tilted upwards (referring to FIG. 7), the poke rod 42 could be limited outside of the limiting ring frame 51(two limiting ring frames 51 configured at interval in the embodiment), or referring to FIG. 6, when the main body 10 is tilted downwards, the poke rod 42 could be limited into the limiting ring frame 51. Thus, no matter whether the main body 10 is tilted upwards or downwards, the first or second limiting member 52, 53 could contact and intervene the poke rod 42 to retain the steering function of the main body 10.

1. An impingement sprinkler comprising:
a main body, comprising of a support, and a sprinkler head located near the lower edge of the support; of which a tubing portion is installed on the lower end of the main body;
a guiding member, located on the support of the main body, including a torsional spring and a swing member; of which, a first stopper is arranged at one side of the swing member, which is located correspondingly to the front end of sprinkler head; the tubing portion located on the lower end of the main body is used for coupling the water pipe, so that water is guided into the support after flowing through the tubing portion, and then sprayed out via sprinkler head to drive swing member to swing back and forth, driving the steering of the main body;
a tilting regulator, arranged between the support of main body and the tubing portion, so that the main body can be tilted to change the outflow angle of sprinkler head;
a steering control member, set at one side of the support of the main body, and including a second stopper and a poke rod located below the second stopper in a swinging and extension state; through intervention of the poke rod, the first and second stoppers can be linked in a corresponding or staggered status, allowing to change the rotational direction of the main body;
a steering limiter, installed at interval on the preset position of the tubing portion for limiting and intervening the poke rod, which comprising:
at least a limiting ring frame, installed at interval on the exterior of the tubing portion;
a first limiting member, having an extension rod pattern, installed on the tubing portion and laterally connected with the limiting ring frame; the first limiting member could link the limiting ring frame to rotate for adjusting the position along the circumferential direction of the tubing portion;
the second limiting member, having an extension rod pattern, installed on the tubing portion and located above or below the first limiting member; it could rotate for adjusting the position along the circumferential direction of tubing portion; it is at least laterally extended to the limiting ring frame;
with this limiting ring frame of the steering limiter, when the main body is tilted for adjustment, the poke rod could be maintained into the limiting ring frame, so that the first or second limiting member could intervene the poke rod to make the main body retain the steering action, preventing the shortcomings that the poke rod could not contact with the first and second limiting members when the main body is tilted upwards or downwards.

2. The device defined in claim 1, wherein the first limiting member located on the steering limiter comprises of an annular assembly portion and a connecting rod extended laterally from the assembly portion; the assembly portion is assembled on the exterior of the tubing portion, and the connecting rod could be connected with the limiting ring frame; the second limiting member comprises of an annular sleeving portion and a stop rod extended from the exterior of the sleeving portion; the sleeving portion could be sleeved on the exterior of the tubing portion.

3. The device defined in claim 2, wherein multiple positioning gears are configured at interval onto inner sides of the assembly portion located on the first limiting member and the sleeving portion on the second limiting member; at least a snap lock is circularly set on the lateral tubing portion, enabling meshed positioning effect when adjusting the first and second limiting members.

4. The device defined in claim 1, wherein the tilting regulator comprises of an axle seat installed on the top of the tubing portion and a pin joint pivoted onto the axle seat; of which, the axle seat is connected to one side of the support set on the main body, and the pin joint could penetrate the support for pivoting of the axle seat, so that the main body could rotate along the axis of pin joint.
